(19) United States
(12) Patent Application Publication
(10) Pub. No.: US 2003/0069963 A1
(43) Pub. Date: Apr. 10, 2003

(54) System and method of quality of service signaling between client and server devices

(76) Inventors: Nikil Jayant, Alpharerta, GA (US); Raghupathy Sivakumar, Atlanta, GA (US); Charles Greg Nicholson, Atlanta, GA (US); Christopher Daniel Gordon, Atlanta, GA (US)

Correspondence Address: SONG K. JUNG, McKenna Long & Aldridge LLP, 1900 K Street, NW, Washington, DC, 20006, US

(21) Appl. No.: 10/254,685

(22) Filed: Sep. 26, 2002

Related U.S. Application Data
(60) Provisional application No. 60/325,116, filed on Sep. 27, 2001.

(51) Int. Cl. G06F 15/173

(52) U.S. Cl. 709/224; 709/225

(57) ABSTRACT

The techniques according to the present invention can be used to optimize signal transmission according to the quality of service (QOS) required or requested at the receiver/destination/client. Such optimization can take into account actual user requirements, human perception minimum requirement or application specific requirements. Scaling can also be provided based on the size of the network or the number of users on the network. The quality of service requirement seeks to trade off or balance quality, complexity, delay, and data rate. In other words, the QOS techniques of the present invention seeks to minimize delay and maximize throughput. That is, to maximize quality within constraints.

This application claims the benefit of U.S. Provisional Patent Application No. 60/325,116, filed on Sep. 27, 2001.

### BACKGROUND OF THE INVENTION

1. Field of the Invention

The present invention relates to a system and method of quality of service signaling between client and server devices, and more particularly, to a system that adjusts parameters based on user-steering and system capabilities.

2. Discussion of the Related Art

Multi-media communications include the transmission, reception and presentation of multi-media data streams, including audio, graphics, video, and synchronized audio and video data.

Multi-media data are presented to a user in a time critical way. For example the auditory experience of the user is hindered if the data are presented too slowly or in an incorrect order. If presented too slowly, the user may hear a lower frequency voice than belongs to the speaker, which decreases the fidelity of the presentation. The decreased fidelity diminishes the utility of audio data, such as music. If data are dropped out or swapped in sequence, the user may be unable to determine what a speaker is saying, which decreases the utility of the communication. As another example, the visual experience of the user is hindered if the video data are presented out of sequence or out of synchronization with the audio data. Out of sequence video data at time scales longer than transmission time for one frame causes smooth motion to become zigzagged as frames are shown out of sequence, destroying the utility for motion critical video such as dance, sporting events, and scientific research. Out of sequence video data on shorter time scales causes portions of a single frame to be presented at incorrect spatial positions on a display screen, so that the image is at best distorted or, at worst, unrecognizable.

Multi-media data takes many forms known in the art. For example, audio data are stored as files of binary data using various formats. In some formats, the data are compressed so that the number of binary digits (bits) when stored in the file is less than the number of bits used during presentation to a human observer. Example image formats, often indicated by extensions on the names of the files used to store their data, include GIF, JPEG, TIFF, bit map (BMP), CGM, DXF, EPS, PCX, PDF, PIC, among others. Example audio formats, often indicated by extensions on the names of the files used to store their data, include waveform audio (WAV), MP3, audio interchange file format (AIFF), unix audio (AU), musical instrument digital interface (MIDI), and sound files (SND) among others. Example video formats, often indicated by extensions on the names of the files used to store their data, include QuickTime, AVI and the Motion Picture Experts Group format (MPEG), among others. Further treatment of the subject is provided in the book Video Communication, (1) Image and Video Compression Standards, V. Bhaskaran and K. Konstantinides, Kluwer Academic, 1995.

FIG. 1 is a block diagram that illustrates a system for delivering multi-media data using computer hardware over a network. An overview of computer hardware is described in more detail in a later section. On a network, a process called a client process (hereinafter, simply “client”) operating on one computer, called a client device, makes a request of another process called a server process (hereinafter, simply “server”) executing on a computer, called a server device, connected to the network. The server performs the service, often sending information back to the client.

A server device 140 contains multi-media data in a file and a media transmission process 142 that transmits the file over wide area network 155 to the media server device 130. The media server device 130 includes a media server process 132 that conditions the data for transmission over local network 150 to a media presentation process 112 on media client device 110. The media presentation process 112 presents the multi-media data to a human user.

The media server device 130, the local network 150 and the media client device 110 constitute an access link that is sometimes called the “last mile,” and sometimes called the “first mile,” of the multi-media communications.

Transport of multi-media data across a network is determined by network protocols implemented by network protocol processes 176 and 156. In conventional systems the network protocol processes on server device and client device are the same. For example network protocol process 176 and 156 are the same.

In some embodiments network 150 or network 155 or both are networks that use the Internet Protocol (IP) described below. In an IP network, for example, the media server device 130 is part of the equipment of an Internet Service Provider (ISP) and the media client device 110 is a personal computer for a particular user.

In other embodiments, network 150 or network 155 or both are non-IP networks, such as a network of cable television links. On a cable television link, the media server device 130 is at the cable headend and the media client device 110 is a television set-top box.

The local network 150 may comprise a direct connection between media server device 130 and media client device 110. In other embodiments, the local network 150 includes one or more transcoders that convert from one type of signal to another, or multiplexers that overlay several data streams on the same line during the same time interval, or both.

The network layer of the Open System Interconnection (OSI) reference model defines the network addresses of devices on the network to control the exchange of a data packet formed at one device on the network with another device on the network. The Internet Protocol (IP) defines logical network addresses for the network layer on the Internet.

The transport layer of the OSI model controls the exchange of data from an operating system on the first device to an operating system on the other device. The transport layer is responsible for making sure that the data in each data packet is not too big to be received, and is delivered error free and in the proper sequence.

Various transport protocols have been developed for the transport layer based on one of two transport models, the Transport Control Protocol (TCP) and the User Datagram Protocol (UDP). TCP attempts to minimize packet losses by allowing for multiple retransmissions for packets as needed, accepting the delay inherent in such a process. UDP attempts to minimize delay and does not permit retransmissions, in general. The delay between sending a data packet from a server and receiving the packet at a client is called network latency. TCP is a good protocol for high-latency-tolerant data traffic. UDP is better suited for communications that are not tolerant of high latency.

According to the invention, one or more media processes 132, 112 and network protocols 176, 156 in the last mile are modified from those used in conventional systems. The modifications are made to improve the quality of multi-media presentations at the media client device 110.

### SUMMARY OF THE INVENTION

Accordingly, the present invention is directed to a system and method quality of service signaling between client and server devices that substantially obviates one or more of the problems due to limitations and disadvantages of the related art.

An advantage of the present invention is to provide user steering of a network.

Another advantage of the present invention is to provide optimal resource allocation for quality service.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method for adapting the components of a communication system includes assembling at least one of an elastic source coding component, an elastic channel coding component, an elastic network component, and an elastic bandwidth enhancement component; obtaining information about a client device and a network; receiving user quality of service requirements; and adjusting at least one of the at least one of the elastic source coding component, the elastic channel coding component, the elastic network component, and the elastic bandwidth enhancement component based on the user quality of service requirements.

In another aspect of the present invention, a method for adapting the components of a communication system, includes determining a plurality of system components to be adjusted; providing user preferences and client device constraints; determining network status; translating the user preferences and the client device constraints into network design properties; computing a plurality of broadband margins for a variety of source coding components and parameter values to determine an optimum broadband; and applying a set of the source coding components and parameter values to the system components.

In another aspect of the present invention, a system for adapting components of a communication system, includes a user; a client; a source; a communication medium between the client and source; an expert system connected to at least two of the user, the client, the source and the communication medium for providing control of any of the network and the source; and a translator between the expert system and at least one of the user, client, source, and communication medium for converting primitives from at least one of the user and the client to engineering design parameters.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram that illustrates a system for delivering multi-media data using computer hardware over a network according to the related art;

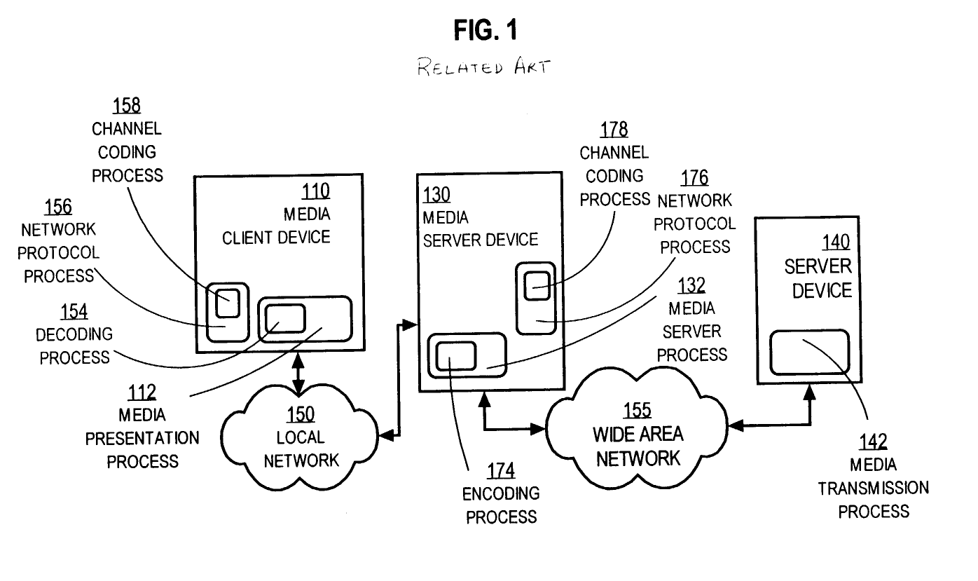

FIG. 2 is a block diagram of an expert system 201 according to an embodiment of the present invention;

FIG. 3 is a representation the flow of QoS signaling according to one embodiment of the present invention;

FIG. 4 is a flow chart that illustrates an exemplary process for forming and using an expert system for joint design of Source Coding (SC), Channel Coding (CC), Network Coding (NC) and Bandwidth Enhancement (BW);

FIG. 5 illustrates mapping of QoS Primitives to QoS parameters;

FIG. 6 illustrates an how an expert system according to one aspect of the present invention may provide QoS signaling to other components of an intergrated architecture; and

FIG. 7 is a block diagram that illustrates an exemplary computer system upon which an embodiment of the invention may be implemented.

### DETAILED DESCRIPTION OF THE ILLUSTRATED EMBODIMENTS

Reference will now be made in detail to an embodiment of the present invention, example of which is illustrated in the accompanying drawings.

According to this invention one or more processes involved with transferring data from a source/sender to a client/user are modified based on user and client quality of service requirement. The processes that can be modified include a plurality of well known processes and other novel processes. Several of such novel processes are described in co-pending U.S. patent application Ser. No. ______, titled “Communication System and Techniques for Transmission from Source to Destination,” filed on Sep. 26, 2002. Examples of processes that can be modified by the present system include a network transport protocol, a media server process, a modem enhancement process, a loss detection process, a dynamic prioritization process, a buffer management process, flow control, error correction coding, data interleaving, loss recovery, rate control and the like.

According to some embodiments, the network transport protocol that packs and unpacks the multi-media data for transferring the data across the local network is modified to optimize performance.

It is expected that changes in the network protocol process will involve changes to the error checking processes applied to received packets. Error checking is frequently based on error protection coding, also called channel coding. An example of channel coding is including a parity bit in the packet header and modifying the content of the parity bit to ensure that any packet sums to an even number (for even parity) or to an odd number (for odd parity). Thus according to aspects of the invention, modifications are considered to the channel coding process included in the network protocol processes, respectively.

In some embodiments the network protocol processes are implemented as a separate process. In other embodiments, the network protocol processes are implemented as sub-processes of the media presentation process and the media server process, respectively, and are included therein.

The optimal packet sizes and other properties of the network protocol processes are expected to depend to some degree on the encoding and decoding of the multimedia data performed by the encoding process of media server process and the complementary decoding process of the media presentation process. Encoding, which occurs before transmission, usually involves multi-media data pre-filtering and compression (reducing the number of bits required to carry the important information in the multi-media data). Decoding, which occurs after transmission, usually involves multi-media decompression (restoring the data to a form used by a presentation process) and post-filtering. For example, the optimal packet size may depend on whether MPEG encoding or AVI encoding is performed on video data. In particular, it is expected that the use of human perception modeling will determine varied importance for different portions of the information in the multi-media data and that the encoding, transport protocol and error checking could all be modified to reflect the varied levels of importance.

According to embodiments of the invention, an expert system is developed that forms an integrated design for the encoding process, the decoding process, and for the network protocol processes and the channel coding processes for media server device and media client device, respectively. The resulting processes may also find utility throughout the transmission system. For example, the expert system designs may be implemented at server device for transmission over wide are network.

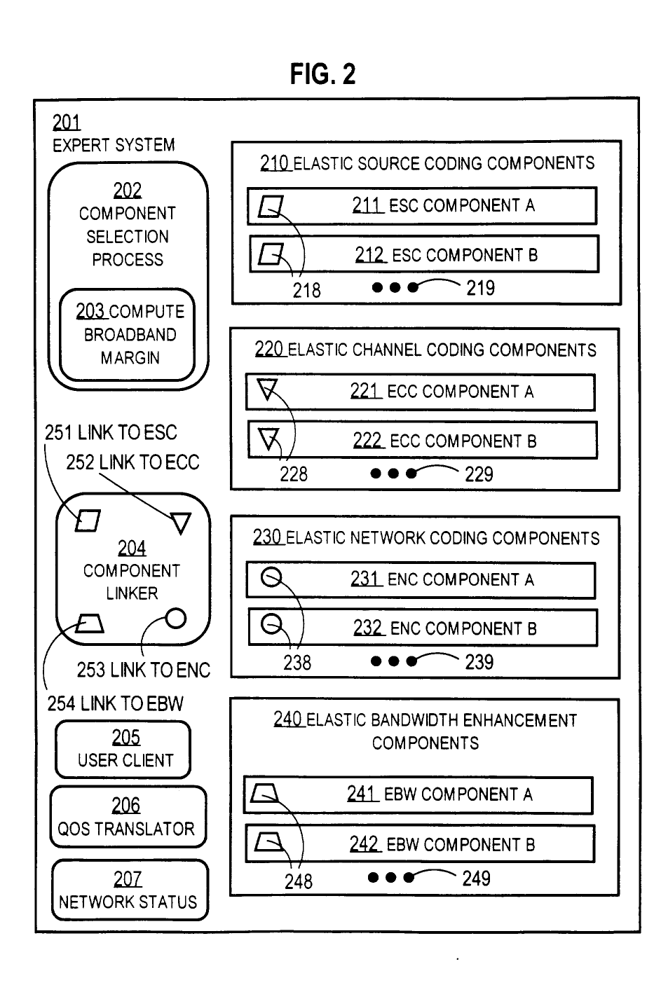

FIG. 2 is a block diagram of an expert system 201 according to an embodiment of the present invention. The expert system of the present invention may reside at the source or destination or may be a distributed system. The expert system may be located anywhere as long as there is communication link so that the signals can be transmitted to and from the various nodes, as discussed below.

As used herein “elastic” indicates that the components are designed with adjustable parameters that can be set through a link with other components. The parameters can be adjusted based on any of a variety of factors, including quality of service (QoS) parameters at the client and network availability parameters. Various components of parameter values allow the components to scale with the size of the network and number of users. By proper selection of values for the parameters, the performance of a single component or multiple components within a system of components may be optimized.

The expert system 201 includes a data structure 210 storing one or more elastic source coding (ESC) components 211, 212, etc. Elastic source components include program instructions that cause a processor to perform source coding at client device or server device or both. The ellipsis 219 indicates that other ESC components may be included in the data structure 210. As used in FIG. 2, source coding refers to encoding and decoding data, which may be multi-media data. For example Video encoding/decoding is represented by component 211 and AVI encoding/decoding by component 212. According to embodiments of the invention, the link 218 is standardized for all ESC components 211, 212, 219.

The expert system 201 includes a data structure 220 storing one or more elastic channel coding (ECC) components 221, 222, etc. Elastic channel components include program instructions that cause a processor to perform channel coding at both client device and server device. The ellipsis 229 indicates that other ECC components may be included in the data structure 220. For example, parity bit channel coding is represented by component 221. According to embodiments of the invention, the link 228 is standardized for all ECC components 221, 222, 229.

The expert system 201 includes a data structure 230 storing one or more elastic network coding (ENC) components 231, 232, etc. Elastic network components include program instructions that cause a processor to perform network coding at client device or server device or both. The ellipsis 239 indicates that other ENC components may be included in the data structure 230. Network coding may include transport protocols for multimedia data such as TCP and UDP and may be represented by components 231 and 232. Other transport protocols that allow different packet lengths and other protocol properties for traffic going from media server device to media client device than are allowed for traffic going in the opposite direction may also be used in conjunction with the present invention. The selected transport protocol determines the data stream or packet that are made from the bit stream that makes up the multi-media data. According to embodiments of the invention, the link 238 is standardized for all ESC components 231, 232, 239.

The expert system 201 includes a data structure 240 storing one or more elastic bandwidth enhancement (EBW) components 241, 242, etc. Elastic bandwidth components include program instructions that cause a processor to perform bandwidth enhancement at client device or server device or both. The ellipsis 249 indicates that other EBW components may be included in the data structure 240. Bandwidth enhancement may include processes to adjust modem efficiency and bandwidth. For example, component 241 provides an elastic algorithm for prioritizing packets. According to embodiments of the invention, the link 248 is standardized for all ESC components 241, 242, 249.

The expert system 201 also includes a components selection process 202. The component selection process determines the best possible combination of the ESC, ECC, ENC and EBW components, and then configures the combination and deploys the components of the best combination across the server and client devices affected. The determination made by the component selection process 202 is based on needs of an application or a communication session with a user.

According to an aspect of the present invention, the component selection process includes a broadband margin (BBM) process 203 to compute a BBM. A BBM can be calculated as the ratio of the data rate as seen by the human user divided by the data rate needed for a given application. The BBM is used as a metric for a given combination of components. It is used to evaluate a given design that specifies the components and is used as a benefit measure in selecting an optimal combination.

To obtain data used in the calculation of BBM and other factors considered by the component selection process 201, the expert system also includes a user client process 205, a network status process 207, and a quality of service (QoS) translator process 206. In one embodiment the processes 205, 206, 207 are implemented as an expert system that will be described in greater detail below.

The user client process 205 is installed on the media client device to provide information about the constraints imposed by the media client device and about the preferences of the human user. For example, the user client process 205 determines whether the media client device is a handheld, laptop or desktop computer or other electronic platform capable of communication between server and client such as a cellular telephone, personal data assistant, electronic audio playback device or the like.

The network status process 207 may be executed on the media server device and determines the status of the local network, including physical channel data and available data rate or bandwidth.

The QoS translator process 206 maps quantities that are intuitive for a user (QoS primitives), such as video quality and display size, into values of engineering parameters, such as those that would be used by a network designer, such as bit rate and error rate. QoS primitives may be based on client capability, user desires or network status. The information is used in conjunction with the information provided from the user by the user client process 205 to determine the data rate needed for a given application that is used in the BBM computation. Table 1 provides lists of example QoS primitives and resulting network design parameters.

TABLE 1
QoS Primitives and Network Design Parameters (QoS Parameters)

| QoS Primitives | QoS Parameters |
|---|---|
| Video Quality | Video Bit Rate |
| Spatial Resolution | Video Bit Error Rate Profile |
| Temporal Resolution | Video Packet Loss Profile |
| Display Size | Audio Bit Rate |
| Audio Quality | Audio Bit Error Rate Profile |
| Bandwidth | Audio Packet Loss Profile |
| Spatial Realism | Variable/Constant/Adaptive Bit Rates |
| Voice Control and Feedback | Global Delay-Jitter Profile |
| | Differential Jitter Profile |

The QoS translator may employ look up tables to map the QoS Primitives to design parameters. The QoS parameters may apply to any of the systems or subsystems in the network or at the source or destination.

The expert system also includes a component linker process 204 that allows information to be shared among an ESC component, an ECC component, an ENC component and an EBW component. The component linker process 204 is employed by the component selection process 202 to combine components for the computation of BBM during selection, and again when configuring the components for deployment on the devices. The component linker process 204 employs the standardized links for each of the components to pass information among the components. That is, the component linker 204 includes a link 251 to the ESC components, a link 252 to the ECC components, a link 253 to the ENC components, and a link 254 to the EBW components.

For example, if the component selection process 202 is able to double throughput for each of the components, then an sixteen-fold increase in throughput is accomplished by using each of the ESC, ECC, ENC, or EBW components. The expert system 201 determines, before the server-client system is deployed, that the increases combine favorably, and that the changes made in one component do not conflict with or negate the increase achieved in another component.

The expert system 201 outputs the configured components based on the component selection process 202. The expert system also outputs other information of use to the network designer, such as the size of the displayed picture.

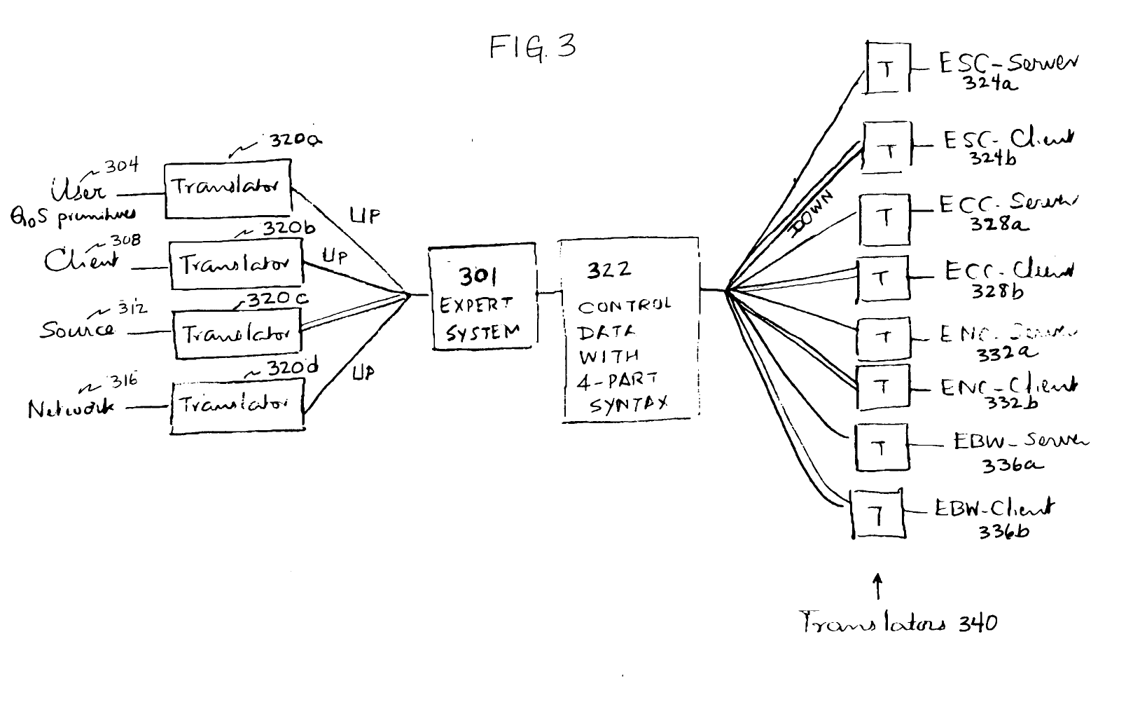

As illustrated in FIG. 3, there may QoS primitives that correspond to each of the user 304, the client 308, the source/server 312 and the network 316. Each of the user 304, the client 308, the source 312 and the network 316 maybe provided with a QoS translator 320a, 320b, 320c, and 320d, respectively, that provides QoS parameters to expert system 301. The expert system 301 determines the optimum system parameters for the requested QoS and provides control data 322 to the adjust ESCs 324a and 324b at the server and at the client 308; ECCs 328a and 328b at the server and at the client, ENCs 332a and 332b at the server and the client, and EBWs 336a and 336b at the server and the client. Because the control data 322 provided by the expert system 301 may be of a predetermined syntax, it may be necessary to provide a translator or translators 340 between expert system 301 and the server and client to translate the control data 322 into a control or operating language to be executed by the various components in the system.

QoS parameters may be transmitted to the expert system as real-time signaling on a per session basis, as a one-time set up per user or client, or the like. The QoS primitives entered by the client or user may be semiquantitative. for example, a user may provide a known level of quality, such as “VHS quality”, and the QoS translator may interpret that semi-quantitative value as a numeric parameter, such as 1 Mbps data rate.

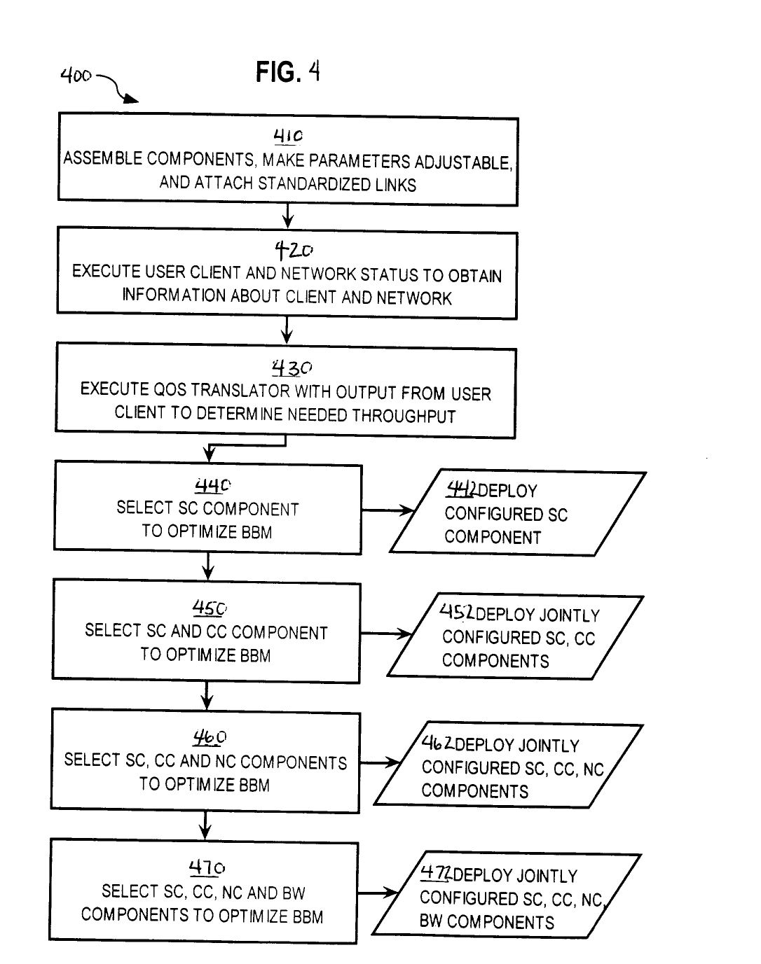

FIG. 4 is a flow chart that illustrates an exemplary process for forming and using an expert system for joint design of Source Coding (SC), Channel Coding (CC), Network Coding (NC) and Bandwidth Enhancement (BW).

In step 410, components are collected, made elastic by allowing one or more parameters to be adjusted, and combined with standardized links, such as an application programming interface (API).

In step 420, the client user process 205 is installed and executed on the media client device to provide user preferences and client device constraints. Also the network status process 207 is installed and executed on a device connected to a local network to determine network status such as information about the physical channel between server device and client device.

In step 430, the QoS translator process 206 is executed to translate data from the user into network design properties used to compute BBM and to select the components and their parameter values.

In step 440, the inputs for an application are combined with the user information from the QoS translator to compute BBM for a variety of source coding components and parameter values, using the component linker process 204. A component with corresponding parameter values the optimize BBM is selected as a configured SC component. If the Source Coding algorithm alone is to be selected, then, in step 442, the configured SC component is generated and deployed on the appropriated devices.

In step 450, a multirate bit stream is available from the configured SC component and used, along with information from the QoS translator 206 and network status process 207, to compute BBM for a variety of channel coding components and parameter values, using the component linker process 204. In some embodiments, the SC component or its parameters or both are also varied in efforts to obtain an optimized BBM. A component with corresponding parameter values that optimizes BBM is selected as a configured CC component. If only the Source Coding and Channel Coding algorithms are to be selected, then, in step 452, the configured SC and CC components are generated and deployed on the appropriated devices.

In step 460, a robust multirate bit stream is available from the configured CC component and used, along with information from the QoS translator 206 and network status process 207, to compute BBM for a variety of network coding components and parameter values, using the component linker process 204. In some embodiments, the CC component or its parameters or the SC component or its parameters or some combination is also varied in efforts to obtain an optimized BBM. A component with corresponding parameter values that optimizes BBM is selected as a configured NC component. If only the Source Coding and Channel Coding and Network Coding algorithms are to be selected, then, in step 462. The configured SC, CC, and NC components are generated and deployed on the appropriated devices.

In step 470, a robust multirate packet sequence is available from the configured NC component and used, along with information from QoS translator 206 and network status process 207, to compute BBM for a variety of bandwidth enhancement components and parameter values, using the component linker process 204. In some embodiments, the SC, CC, and NC components or their parameters or some combination is also varied efforts to obtain an optimized BBM. A component with corresponding parameter values that optimizes BBM is selected as a configured BW component. In step 462, the configured SC, CC, NC and BW components are generated and deployed on the appropriated devices.

Using the configured SC, CC, NC and BW components, a robust prioritized multirate packet sequence is produced that is optimal in some sense for the user and application on the actual network. In various embodiments, the components are then deployed on a broadband channel or a multi-user network or both. Because selection depends on actual network status, the configured combination is optimal as the number of users and network capacity change. That is the solution scales with the size of the network.

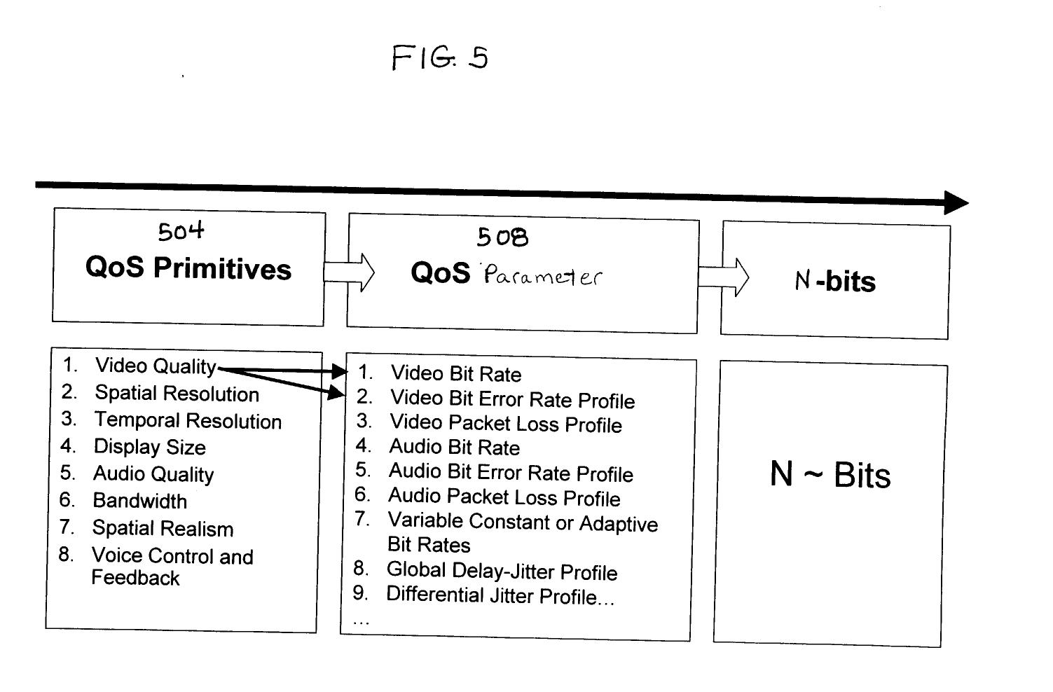

As illustrated in FIG. 5, QoS primitives 504 may be translated or mapped into corresponding QoS parameters 508. Such mapping may be performed at the client or at the source. In addition, such mapping can be coded into a signal of a predetermined number of fields, such as an digital signal having “N” bits 512. The code provided by the N bit signal can be used to provide signaling to the expert system or any of the components of the communication network to adjust the actual parameters of the user, client, network or source/server to implement the optimization determined by the expert system. The number of bits “N” may depend on the number of states for each of the QoS parameters or on the number of control states of the expert system or both. For example, using a binary coded system having four bits, 16 states can be represented by the N bit signal.

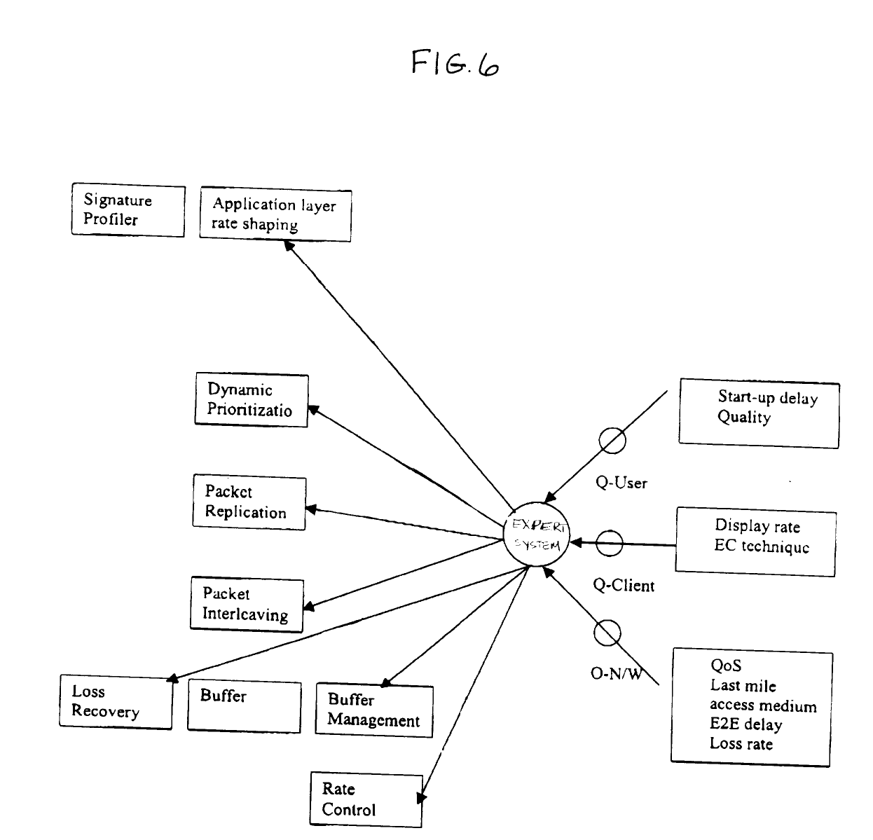

As illustrated in FIG. 6, the QoS parameters can impact several different components of a communication system. For example, the QoS parameters can directly affect application layer rate shaping, dynamic prioritization, packet replication, loss detection and recovery, packet interleaving, loss profiling and recovery, buffer management, rate control. For example, client capabilities that can be affected by the QoS parameters include screen size, resolution, media processing techniques (error concealment, post-processing, user parameters, etc.); user desires that can be affected include picture size, minimum quality requirements (e.g., speed, color), cost, start-up delay, interactivity requirements; delivery infrastructure that can be affected include last-mile access medium (e.g., cable, DSL, modem, wireless). At the application server, rate control, adaptive replication, preprocessing and profiling can be affected by the expert system.

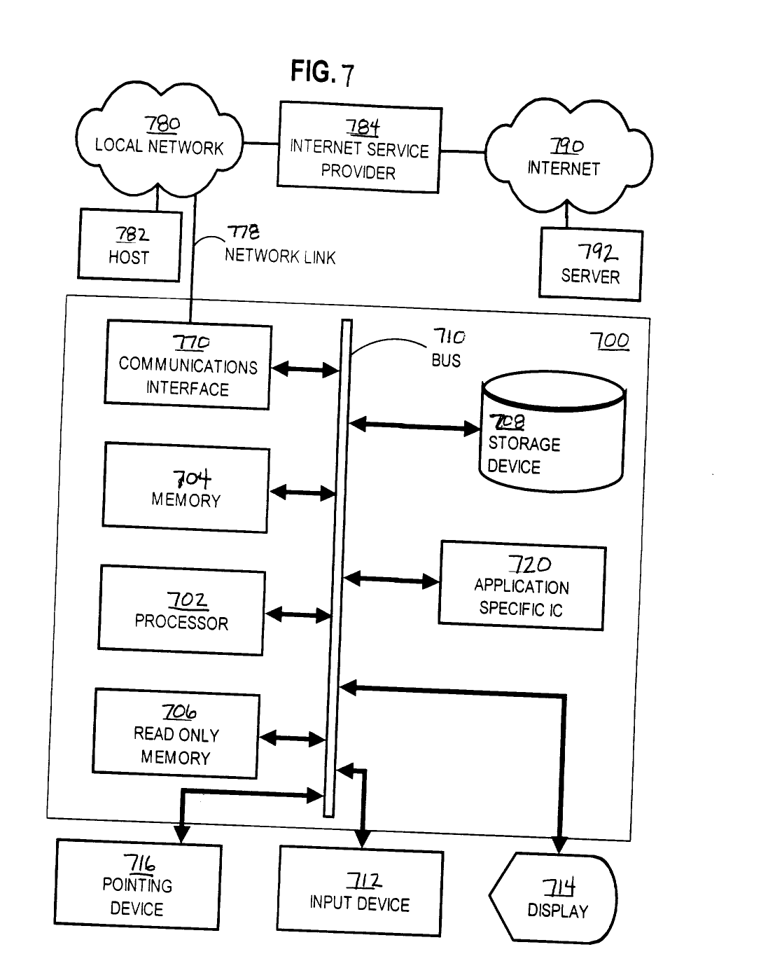

As illustrated in FIG. 7, the QoS expert system may provide QoS signaling to the application layer, the dynamic priority calculation, the packet replication, packet interleaving, loss recovery, buffer manager, and rate control. For example, the application layer may receive QoS information that adjusts the error correction techniques or the start up delay; the dynamic priority calculation may receive information that adjusts the display rate, the start-up delay, or the E2E delay. The packet replicator may include QoS information about the network loss rate. The loss recovery may be affected by QoS information such as the display rate and quality. The rate control may be adjusted according to QoS information about the quality requested by the user and the last mile access medium.

FIG. 7 is a block diagram that illustrates an exemplary computer system 700 upon which an embodiment of the invention may be implemented. While the present example is discussed in the context of a local area network (LAN), the principles of the present invention are applicable in any server to client network having any source components, network components, bandwidth components or coding components that are adjustable.

Referring to FIG. 7, computer system 700 includes a communication mechanism such as a bus 710 for passing information between other internal and external components of the computer system 700. Information is represented as physical signals of a measurable phenomena, typically electric voltages, but including, in other embodiments, such phenomena as magnetic, electromagnetic, pressure, chemical, molecular and atomic interactions. For example, north and south magnetic fields, or a zero and non-zero electric voltage, represent two states (0, 1) of a binary digit (bit). A sequence of binary digits constitute digital data that is used to represent a number or code for a character. A bus 710 includes many parallel conductors of information so that information is transferred quickly among devices coupled to the bus 710. One or more processors 702 for processing information are coupled with the bus 710. A processor 702 performs a set for operations on information. The set of operations include bringing information in from the bus 710 and placing information on the bus 710. The set of operations also typically include comparing two or more units of information, shifting positions of units of information, and combining two or more units of information, such as by addition or multiplication. A sequence of operations to be executed by the processor 702 constitute computer instructions.

Computer system 700 also includes a memory 704 coupled to bus 710. The memory 704, such as a random access memory (RAM) or other dynamic storage device, stores information including computer instructions. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of computer instructions. The computer system 700 also includes a read only memory (ROM) 706 or other static storage device coupled to the bus 710 for storing static information, including instructions, that is not changed by the computer system 700. Also coupled to bus 710 is a non-volatile (persistent) storage device 708, such as a magnetic disk or optical disk, for storing information, including instructions, that persists even when the computer system 700 is turned off or otherwise loses power.

Information, including instructions, is provided to the bus 710 for use by the processor from an external input device 712, such as a keyboard containing alphanumeric keys operated by a human user, or a sensor. A sensor detects conditions in its vicinity and transforms those detections into signals compatible with the signals used to represent information in computer system 700. Other external devices coupled to bus 710, used primarily for interacting with humans, include a display device 714, such as a cathode ray tube (CRT) or a liquid crystal display (LCD), for presenting images, and a pointing device 716, such as a mouse or a trackball or cursor direction keys, for controlling a position of a small cursor image presented on the display 714 and issuing commands associated with graphical elements presented on the display 714.

In the illustrated embodiment, special purpose hardware, such as an application specific integrated circuit (IC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a two-way communication coupling to a variety of external devices that operate with their own processors, such as printers, scanners and external disks. In general the coupling is with a network link 778 that is connected to a local network 780 to which a variety of external devices with their own processors re connected. For example, communication interface 770 may be a parallel port or serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that coverts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends and receives electrical, acoustic of electromagnetic signals, including infrared and optical signals, that carry information streams, such as digital data. Such signals are examples of carrier waves.

The term computer-readable medium is used herein to refer to any medium that participates in providing instructions to processor 702 for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, such as acoustic waves and electromagnetic waves, including radio, optical and infrared waves. Signals that re transmitted over transmission media are herein called carrier waves.

Common forms of computer-readable media include, for example, a floppy disk, a flexible disk, a hard disk, a magnetic tape, or any other magnetic medium, a compact disk ROM (CD-ROM), or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read.

Network link 778 typically provides information communication through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790. A computer called a server 792 connected to the Internet provides a service in response to information received over the Internet. For example, server 792 provides information representing video data for presentation at display 714.

The invention is related to the use of computer system 700 for implementing the techniques described herein. According to one embodiment of the invention, those techniques are performed by computer system 700 in response to processor 702 executing one or more sequences of one or more instructions contained in memory 704. Such instructions, also called software and program code, may be read into memory 704 from another computer-readable medium such as storage device 708. Execution of the sequences of instructions contained in memory 704 causes processor 702 to perform the method steps described herein. In alternative embodiments, hardware, such as application specific integrated circuit 720, may be used in place of or in combination with software to implement the invention. Thus, embodiments of the invention are not limited to any specific combination of hardware and software.

The signals transmitted over network link 778 and other networks through communications interface 770, which carry information to and from computer system 700, are exemplary forms of carrier waves. Computer system 700 can send and receive information, including program code, through the networks 780, 790 among others, through network link 778 and communications interface 770. In an example using the Internet 790, a server 792 transmits program code for a particular application, requested by a message sent from computer 700, through Internet 790, ISP equipment 784, local network 780 and communications interface 770. The received code may be executed by processor 702 as it is received, or may be stored in storage device 708 or other non-volatile storage for later execution, or both. In this manner, computer system 700 may obtain application program code in the form of a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to an infra-red signal, a carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

The system of the present invention is applicable in a variety of environments include point-to-point communication systems, unicasts, multicasts, two-way multi-casts, multi-user multicasts and the like. In a multi-user environment, one of the nodes of the system may coordinate the feedback messages and host the translator or the expert system may be distributed. The processes are applicable in systems of data flowing in more than one direction and signaling flowing in more than one direction. Also, the system of the present invention is applicable in any environment or transmission medium

The principles disclosed herein provide for a system that is flexible. Such flexibility allows for broad application of the principles of QoS signaling. For example, the location originating the QoS signal may be collocated with the user, but also may be present in a distributed system for a plurality of users or for a plurality of steering inputs, such as the user requirement, the network capabilities, the receiver capabilities, etc.

Moreover, the server may include metadata that offer a variety of interactive features and overlays, such as viewing Internet (world wide web) content with a television experience. The principles of the present invention can thus provide for steering of a variety of features, including presentation and content, which includes the finally consumed content. In this way, the principles of the present invention are applicable to interactive video and interactive television. For example, a client device, such as a set top box, may use a user profile to assess information and provide filtering to make efficient use of metadata from the server and overall transmitted or broadcast information.

According to one aspect of the present invention, the QoS signaling can be stored in different places in the architecture between the source and the destination and can be transmitted in as feedforward or feedback and can take advantage of upward links, such as in DOCSIS cable, and distributed computing and communications.

The techniques according to the present invention can be used to optimize signal transmission according to the quality of service (QOS) required or requested at the receiver/destination/client. Such optimization can take into account actual user requirements, human perception minimum requirement or application specific requirements. Scaling can also be provided based on the size of the network or the number of users on the network. The quality of service requirement seeks to trade off or balance quality, complexity, delay, and data rate. In other words, the QOS techniques of the present invention seeks to minimize delay and maximize throughput. That is, to maximize quality within constraints.

An expert system may be provided to coordinate inputs for quality of service. For example, input for quality of service requirements can be at four different “levels” of the communication between the sender and the receiver: the network, the source, the client application or device, and the user. Such input can also be provided via real time feedback or on a per session basis, on a market (customer) basis or on a market (domain) basis.

Quality of Service primitives (i.e., communication quality factors that can be adjusted according to sender, receiver, client application and user capabilities and requirements) can include, for example, video quality; spatial resolution; temporal resolution; display size, quality and resolution; audio quality; bandwidth; spatial realism; voice control and feedback; start up delay tolerance; midstream latency; etc. or the like. The QOS primitives can be translated into network or system parameters that can actually be implemented by various components of the communication system. Such parameters include video bit rate, video bit error rate profile, video packet loss profile, audio bit rate, audio bit error rate profile, audio packet loss profile, variable/constant/adaptive bit rates, global delay jitter profile, differential jitter profile, etc. or the like.

The QOS primitives can be assessed and translated according to an expert system which can provide input to other aspects, techniques or components of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for adapting the components of a communication system, comprising:
assembling at least one of an elastic source coding component, an elastic channel coding component, an elastic network component, and an elastic bandwidth enhancement component;
obtaining information about a client device and a network;
receiving user quality of service requirements; and
adjusting at least one of the at least one of the elastic source coding component, the elastic channel coding component, the elastic network component, and the elastic bandwidth enhancement component based on the user quality of service requirements.

2. The method of claim 1, further comprising computing a broadband margin.

3. The method of claim 2, wherein the broadband margin is a ratio of data rate as seen by a human divided by a data rate required for a given application.

4. The method of claim 1, wherein the elastic source component includes program instructions that cause a processor to perform source coding at at least one of a client device and a server device.

5. The method of claim 1, wherein the elastic channel component includes program instructions that cause a processor to perform channel coding at a client device and a server device.

6. The method of claim 1, wherein the elastic network component includes program instructions that cause a processor to perform network coding at at least one of a client device and a server device.

7. The method of claim 6, wherein the network coding includes applying transport protocols for multimedia data

8. The method of claim 1, wherein the elastic bandwidth enhancement component includes program instructions that cause a processor to perform bandwidth enhancement at at least one of a client device and a server device.

9. The method of claim 1, wherein adjusting the elastic bandwidth enhancement component includes adjusting modem efficiency.

10. The method of claim 1, wherein adjusting the elastic bandwidth enhancement component includes adjusting bandwidth.

11. The method of claim 1, further comprising:
receiving quality of service primitives from the user;
mapping the quality of service primitives to engineering parameters; and
performing adjusting the at least one of the at least one of the elastic source coding component, the elastic channel coding component, the elastic network component, and the elastic bandwidth enhancement component by changing the engineering parameters of the at least one of the at least one of the elastic source coding component, the elastic channel coding component, the elastic network component, and the elastic bandwidth enhancement component.

12. The method of claim 11, wherein the quality of service primitives include at least one of video quality, spatial resolution, temporal resolution, display size, audio quality, bandwidth, spatial realism, voice control and feedback.

13. The method of claim 11, wherein the engineering parameters include at least one of video bit rate, video bit error rate profile, video packet loss profile, audio bit rate, audio bit error rate profile, audio packet loss profile, variable bit rate, constant bit rate, adaptive bit rate, global delay-jitter profile, and differential jitter profile.

14. The method of claim 11, wherein the quality of service primitives correspond to at least one of a user, the client device, a source and the network.

15. The method of claim 11, wherein the quality of service primitives are mapped to engineering parameters as a signal having N fields such that the signal represents a plurality of states.

16. A method for adapting the components of a communication system, comprising:
determining a plurality of system components to be adjusted;
providing user preferences and client device constraints;
determining network status;
translating the user preferences and the client device constraints into network design properties;
computing a plurality of broadband margins for a variety of source coding components and parameter values to determine an optimum broadband; and
applying a set of the source coding components and parameter values to the system components.

17. The method of claim 16, wherein the network design properties include at least one of video bit rate, video bit error rate profile, video packet loss profile, audio bit rate, audio bit error rate profile, audio packet loss profile, variable bit rate, constant bit rate, adaptive bit rate, global delay-jitter profile, and differential jitter profile.

18. A system for adapting components of a communication system, comprising:
a user;
a client;
a source;
a communication medium between the client and source;
an expert system connected to at least two of the user, the client, the source and the communication medium for providing control of any of the network and the source; and
a translator between the expert system and at least one of the user, client, source, and communication medium for converting primitives from at least one of the user and the client to engineering design parameters.
